(19) United States
(12) Patent Application Publication
(10) Pub. No.: US 2007/0293380 A1
(43) Pub. Date: Dec. 20, 2007

(54) Fastening Device and Associated Tool

(76) Inventors: Manfred Kausch, Wermelskirchen (DE); Hans-Josef Kulmer, Remscheid (DE); Torsten Sommer, Remscheid (DE); Peter Widra, Remscheid (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/547,433

(22) PCT Filed: Feb. 25, 2004
(86) PCT No.: PCT/DE04/00345

§ 371 Date: May 15, 2007

(30) Foreign Application Priority Data
Feb. 25, 2003 (DE) 103 08 223.9

(51) Int. Cl. B23Q 3/00

(52) U.S. Cl. 483/31; 483/1

(57) ABSTRACT

In order in fast clamping of a tool to a machine tool to provide a small amount of play between the tool (2) and the fastening device (1) in a rest position and/or in operation, there is proposed a fastening device having at least one projection of a closure means which can be actuated without the use of a tool and with which the fastening device, wherein in the closed position the projection (410) of the fastening device engages over an associated closure surface (220) of the tool and the tool body is axially secured and held non-rotationally. Structural measures are adopted both on the tool and also on the fastening device in that case in order to keep down the axial spacing, which is necessary for establishing a positively locking relationship between the fastening device and the tool, between the support (390) for the tool and the at least one projection (410) of the fastening device and/or in order to produce, during operation, in particular upon the occurrence of external forces such as braking or tilting forces acting on the tool, an additional force which holds the tool down On the support, whereby the positively locking relationship can be maintained and stabilised.

The invention concerns a fastening device for a machine tool, with which a tool can be fastened to the machine tool, and an associated tool.

The tool can be in particular a cutting, thrust, diamond, brush, polishing or fan-type grinding disc.

The use of such tools can be substantially simplified by the provision of a tool-less quick-action clamping system with which the tool can be mounted to the machine tool.

German laid-open application DE 100 174581 describes a grinding machine tool receiving means having an entrainment device, by way of which a tool can be operatively connected to a drive shaft. In that case the insertable tool can be connected to the entrainment device by way of at least one latching element which is mounted movably against a spring element, wherein in an operative position of the insertable tool the latching element is in latching engagement and fixes the insertable tool in positively locking relationship for use thereof.

International publication WO 01/98029 discloses a fastening device which can be mounted on a machine tool, wherein the fastening device has projections for a closure means which can be actuated without the use of a tool and which in a closure position engages over closure surfaces of the tool, whereby the tool body is axially secured and held non-rotatably. The projections of the fastening device and a support for the tool are arranged axially displaceably relative to each other, wherein the axial displacement path can be blocked by a centrifugal force device, whereby a positively locking engagement is fixed in the closure position between the fastening device and the associated tool for operation thereof.

The object of the invention, in the use of a quick-action clamping system of that kind, for the purposes of increasing the level of security, is to provide a small amount of play between the tool and the fastening device in the closure position in the rest condition and/or in operation.

In respect of the device that object is attained by a fastening device having the features set forth in claim 1 and claim 3 respectively and a tool having the features of claim 15.

In that respect the fastening device for a machine tool includes at least one, in particular radially outwardly facing, projection of a closure means which can be actuated without a tool, with which the fastening device can be releasably connected to the tool, wherein in the closure position the projection of the fastening device engages over an associated, in particular radially inwardly facing closure surface of the tool and the tool body is axially secured and held non-rotatably. A means for transmission of the drive torque from the machine tool to the tool is provided with a drive surface which extends inclinedly with respect to the axis, wherein the tool bears against the drive surface in the operative position of the tool. With the specified structural configuration of the fastening device, it is possible to produce an axially acting force on the tool if the tool, for example by virtue of external forces acting thereon, in operation, lifts off the support on the fastening device, so that in operation the tool is pressed against the support of the fastening device.

In a further solution the fastening device includes a centrifugal force device which blocks or disables axial displaceability of the at least one projection and the support for the tool. In that arrangement the centrifugal force device has at least one centrifugal force element which is urged radially outwardly by a force means, and a means which converts the force on the at least one centrifugal force element, for producing an axially directed force for clamping the tool in the fastening device. In this case also the specified structural configuration of the fastening device according to the invention provides that, in operation of the fastening device, in addition to a force means acting in the rest position, an operating force is produced, which acts in the axial direction and which presses the tool onto the support thereof on the fastening device. The fastening device according to the invention is so designed that the at least one centrifugal force element is in a substantially identical position in the radial direction, both when the machine tool is in a stationary condition and also when the machine is rotating. This means that a positively locking engagement between the tool and the fastening device can be provided when the machine is stationary by virtue of axially operative force means, wherein that positively locking engagement is secured and/or stabilised in operation by the action of the centrifugal force device. That means that it is also possible to provide a continuous and uniform, axially directed force in operation of the tool as the reversal of force from the centrifugal force to the axially directed force for clamping the tool can be effected substantially without movement. The centrifugal force element cannot build up a high level of kinetic energy which accordingly also does not have to be reduced. As moreover the centrifugal force element is biased in the same direction as that in which the centrifugal force acts, that arrangement ensures a continuous transfer of force from an operative rest position to a working mode of operation.

The object of the invention is further attained by any tool which is adapted to co-operate with a fastening device according to the invention. For that purpose it includes a tool body in the form of a circular disc, which has a central opening for fastening to a machine tool and at least one, in particular radially inwardly facing closure surface of a closure means which can be actuated without a tool and with which the tool can be brought into positively locking relationship with the fastening device and the tool body is axially secured and held non-rotatably.

The tool according to the invention, in conjunction with the associated fastening device, can have a cam control means which is of such a configuration that upon rotation of the tool relative to the fastening device to produce a closure position between the tool and the fastening device a cam can be guided by way of a surface having a control surface with at least two ramps, wherein at least one projection of the fastening device is raised against a mechanical force means axially relative to a condition of support of the tool on the fastening device and is lowered again. As the man skilled in the art will see, in accordance with the invention the cam of the cam control means can be arranged either on the tool or on the fastening device. Accordingly, depending on the respective embodiment adopted, the control surface is disposed either on the tool or on the fastening device.

The tool according to the invention can be in particular a cutting, thrust, diamond, brushing, polishing or fan-type grinding disc.

In that respect, a tool according to the invention can be distinguished in that the at least one closure surface is provided by a partially peripherally extending segment which also has a means for axially guiding a cam during the clamping operation on the at least one projection on the fastening device. The configuration of the tool according to the invention can provide that the axial displaceability between the support and the at least one projection on the fastening device can be kept as small as possible as the projection on the fastening device, during the clamping operation, is automatically controllable axially relative to the support of the tool in order to move the tool and the fastening device into an operative position, that is to say into a condition of positively locking relationship. In addition, with the tool configuration specified, a purely rotary movement in the clamping operation for the tool, can be converted with a torque step-down effect into an axial displacement of the support relative to the at least one projection on the fastening device. That permits manual clamping of the tool even against high levels of axial biasing forces, for example against axially operative springs with a high spring rate.

The invention is based on the idea of making quick-action clamping of a tool on a machine tool particularly secure, insofar as the axial spacing necessary for affording a positively locking connection between the fastening device and the tool, between the support for the tool and the at least one radial projection of the fastening device, is kept small and/or it is provided that, during operation, particularly when external forces occur such as braking or tilting forces acting on the tool, an additional force is produced which holds the tool down on the support, whereby the above-described positively locking engagement can be maintained and stabilised.

In accordance with the invention the term “radially outwardly facing projection” embraces a portion or a region of the fastening device which, when the closure means is closed, that is to say in the closure position, engages over a portion or a region of the tool, which provides the specified closure surface. Preferably provided for the closure means on the fastening device are a plurality of radially outwardly facing projections which each engage over a respectively associated, radially inwardly facing closure surface of the tool so that it is possible to achieve substantially rotationally symmetrical axial fixing of the tool. To avoid an unbalance, the components on the tool and on the fastening device, which afford the positively locking engagement, should preferably be arranged symmetrically.

Advantageous configurations are set forth in the appendant claims.

The first solution of a fastening device according to the invention makes it possible to provide for symmetrical application of the drive force to the tool and thus symmetrical production of an axially directed force on the tool, by the provision of a plurality of entrainment members for transmitting the drive force to the tool. For example entrainment members can be placed in peripherally spaced relationship, in particular on an annular flange which is rigidly connected to the support, wherein each entrainment member bears with its drive surface which is oriented inclinedly relative to the axis against an associated drive surface of the tool. The direct connection of the support and the entrainment member affords the advantage that the entrainment members press the tool directly onto the support without the need for the transmission of force by way of further components. In order to achieve optimum pressure distribution and a stable position, each of the entrainment members bears in positively locking relationship with its drive surface against its associated drive surface on the tool. The configuration of the entrainment members can assume any desired appropriate shape in order to provide for drive torque transmission. In that respect it may be sufficient if the entrainment member extends out a few millimetres relative to the height of the support of the tool, in which case the drive surface preferably extends radially.

Desirably the at least one centrifugal force element can have a radially outwardly extending conical or wedge surface which, when the machine tool is not rotating, that is to say in a rest position, can be moved by a radially acting force means such as a suitably arranged spring to bear against an associated conical or wedge surface of an axially movable segment which is operatively connected to the at least one projection of the fastening device. By virtue of that structural feature, the reversal of the force which acts on the centrifugal force element in the radial direction both when the centrifugal force element is at rest and also when the centrifugal force element is rotating, into the desired axial direction, can be implemented for clamping the tool. In that respect it is advantageous if the at least one projection of the fastening device is connected rigidly to the segment which bears against the associated surface of the centrifugal force element. A transmission effect which is particularly free of material wear can be achieved if the centrifugal force element has a radially outward conical surface, in particular extending at an angle of 45° relative to the axis, which bears against a conical surface, of an associated configuration, of the axially movable segment, so that both surfaces are in contact with each other substantially over the entire extent thereof. The use of conical surfaces for force deflection is advantageous in the present case as the components are of a rotationally symmetrical configuration and it is thus possible to provide a large surface contact with conical surfaces.

In regard to the nature of the force reversal, it is particularly desirable if the centrifugal force element is positively guided immovably in the axial direction and the associated cone segment is positively guided immovably in a direction in perpendicular relationship to the axis of the fastening device. Accordingly the centrifugal force element can move only in the radial direction and the cone segment can move only in the axial direction so that a motion coupling can be of such a nature that when a centrifugal force does not act on the centrifugal force element and in the event of a relative axial movement of the at least one projection away from the support of the tool, the centrifugal force element moves radially inwardly, wherein that movement is opposed by an above-described force means such as a spring.

Regarding the configuration of a fastening device of particularly low structural height, it can be provided that it includes a base element which has the support for the tool and an annular element which can be introduced axially into the base member and which is displaceable axially relative thereto and at the outer periphery of which are arranged a plurality of peripherally spaced, radially outwardly facing projections which, as described above, in a closure position, engage over the closure surfaces of the tool to provide a positively locking engagement with the tool. In order to transmit a radial force to the annular element, a plurality of peripherally spaced conical segments each having a respective radially extending contact surface can be provided at the inner periphery of the annular element, the contact surface respectively co-operating with one of the above-described radially outward surfaces of a centrifugal force element.

In the first solution according to the invention for the fastening device, it can be provided that disposed at the inner periphery of the annular element are a plurality of peripherally spaced flange segments in which axially acting force means such as springs are supported, for clamping the tool in the fastening device. In that way it is possible to provide that, even when the fastening device is at rest, a holding or clamping force is provided for maintaining the positively locking relationship between the tool and the fastening device if for example the machine tool is transported with a tool in a mounted clamped position thereon.

In order to provide for rotationally securing the annular element in the base element, it can be provided that a leg which is rigidly connected to the base element and which is peripherally extensive and which extends in the axial direction engages in positively locking relationship into the gap on the annular element, which is formed by two peripherally adjacent conical, wedge or flange segments. That leg therefore forms a positive guide means for the annular element in the base element. The annular element is accordingly entrained by the base element upon rotation thereof and is displaceable axially therein against the spring force and/or the centrifugal force. By virtue of the usual high centrifugal forces, with angle grinding machines being operated at 13,000 revolutions per minute, axial displacement of the centrifugal force element inwardly and thus release of the positively locking connection between the tool and the fastening device can however be reliably prevented.

In order to seal off the annular element relative to the base element, it can be provided that the annular element has a peripheral groove for accommodating a seal in relation to the base element. In order to prevent the annular element striking against the bottom of the base element when the tool is not clamped in position, it can be provided that the annular element is supported at the entrainment members against the base element.

If the entrainment members are shaped or mounted directly on the base element, the base element is accordingly to be rigidly connected to the machine tool in order to transmit the drive torque of the machine to the entrainment members.

As stated hereinbefore the fastening device according to the invention is so designed that the axial displaceability, which is necessary to provide the positively locking relationship between the tool and the fastening device, between the support and the fixing device can be sensed by the radially outwardly facing projection. For that purpose it has a radially extensive cam, extending towards the machine tool, of a cam control means, with a front contact surface and a rear contact surface.

For sealing off the cam portion at the outwardly facing projection of the fastening device, it can be provided that a horizontally extending leg extends from the cam in the direction of rotation, onto an associated entrainment member. In that way the projection can be supported against the entrainment member, when the tool is not in the clamped position.

The described construction is also advantageous in particular for the reason that the axial displaceability of the projection relative to the support, that is to say in this case the annular element relative to the base element, makes it possible to compensate for fluctuations in thickness of the tool so that nonetheless a positively locking connection is provided between the fastening device and the tool, and that connection is secured by the application of the axial force for clamping the tool in operation of the machine.

An extremely advantageous fastening device can be afforded if the two specified solutions are combined together, that is to say it has both at least one entrainment member which extends inclinedly relative to the axis, and also the specified centrifugal force device.

In a further configuration of the tool according to the invention which can be moved into a closure position with the fastening device according to the invention, the means for axially guiding the cam during the clamping operation has a first ramp which is of an inclined configuration and which extends away from the machine tool and behind the first ramp in the direction of rotation a second ramp which is of an inclined configuration in the plane perpendicular to the axis and which extends towards the machine tool. The control surface which is formed in that way provides that, during the clamping operation which is effected in the form of a purely rotary movement of the tool relative to the fastening device, the axial spacing between the support surface and the projection firstly increases and thereafter decreases again. The specific configuration of the first ramp which serves as a run-on ramp on the one hand exactly predetermines the axial rising movement of the projection on the fastening device by virtue of the axial extent of the ramp and also, by virtue of the peripheral extent thereof, fixes the torque which is to be manually applied against the axially operative force means. Accordingly it is possible to provide a torque step-down effect which makes it possible to use very strong axially operative force means in the fastening device, which even without the support of the described operating forces which occur, in the axial direction, hold the tool in positively locking relationship with the fastening device. It will be appreciated that the described advantageous torque step-down effect can also be afforded if, as stated hereinbefore, the control surface is arranged on the fastening device and thus the cam to be guided is on the tool.

It is particularly advantageous if the first ramp of the control surface is at the same time in the form of a drive surface which co-operates with an entrainment member and by way of which the motor torque can be transmitted to the tool.

For the specific configuration of the control surface on the tool, it is possible to envisage the provision of a plurality of configurations and in particular it is also possible to provide more than two ramps. It is particularly advantageous if at least one of the ramps is of such a nature that it can transmit braking forces from the tool to the projection of the fastening device, in particular the cam of the fastening device.

It has proven to be advantageous for the first ramp to be at an angle of between 25° and 45°, preferably at 30°, in a plane perpendicularly to the axis, wherein the second ramp is advantageously at an angle of ≦30°.

It is advantageous if the segment on the tool, in the direction of rotation, at the peripheral end thereof, has over the radial width a leg which provides coverage means for the positively locking engagement and which extends axially with respect to the end face which is remote from the machine tool. The front boundary surface of the leg in the direction of rotation can desirably be such that an air flow is produced, which permits the grinding particles to be blown off the quick-action clamping system in operation thereof. That leg on the other hand can be used to provide connecting means for a coverage means which can be connected to the tool at the end remote from the machine tool, whereby it is possible to provide particularly advantageous dust protection.

The at least one segment on the tool which provides the at least one closure surface of the tool can either be formed directly on the tool body or however it can be provided on a carrier device which is provided in an opening of the tool body and is fixed thereto. The carrier device can be made from plastic material and can be securely mounted to a tool body by way of an adhesive process. The carrier device can also be made from metal and for example can be pressed in position in production of the tool body.

The advantageous method according to the invention for the tool-free clamping of a tool is distinguished in that, after the tool and the fastening device have been axially brought together in a conventional manner the axial spacing between the support surface and the projection on the fastening device is not increased by virtue of the fact that an axial force has to be applied to the support by pressing against the tool, in the axial direction. Instead, an axial displacement is produced by a pure rotary movement by means of a force deflection effect in order to increase the axial spacing between the specified components so that a positively locking engagement can be produced between the tool and the fastening device. When the closure position is reached, by corresponding axial control of at least one cam, the axial spacing between the support and the projection on the fastening device is reduced again, whereby finally the tool comes into a condition of unsecured positively locking relationship with the fastening device, the positively locking relationship being secured in operation by the described operating forces which act on the tool.

Advantageously, in the rotary movement to produce a closure position by way of a cam control between the tool and the fastening device the cam is guided by way of a control surface with at least two ramps, wherein at least one projection of the fastening device is raised axially against a mechanical force means for the tool to be supported against the fastening device and is lowered again.

Advantageously, guidance of the cam is effected continuously by way of the control surface throughout the entire clamping operation so that the cam control can also be used for the unclamping operation, that is to say for releasing the tool from the fastening device. For that purpose a relative rotary movement of the tool with respect to the fastening device can be easily produced, that rotary movement being in the opposite direction to the movement involved in the clamping operation.

By virtue of the different arrangement of the parts of the cam control on the fastening device and the tool respectively, which is possible in accordance with the invention, in a first embodiment in the rotary movement a cam on the fastening device can be guided by way of a control surface on the tool and in another embodiment a cam on the tool can be guided by way of a control surface on the fastening device. In the first case, the cam can be disposed on a projection on the fastening device, the control surface being arranged at the closure surface of the tool. In the second case described, the control surface can be arranged at the projection of the fastening device while the can is arranged at the closure surface of the tool.

The invention is described hereinafter by means of the description of a plurality of embodiments with reference to the accompanying drawings in which:

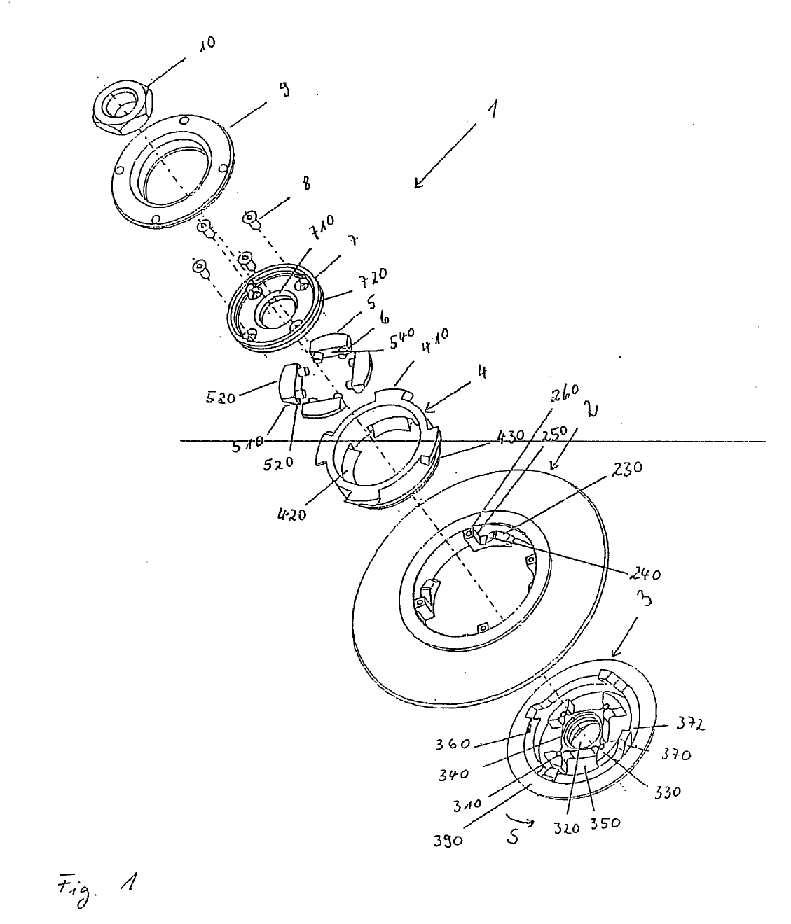

FIG. 1 is an exploded view showing a first fastening device according to the invention together with the tool of an associated configuration,

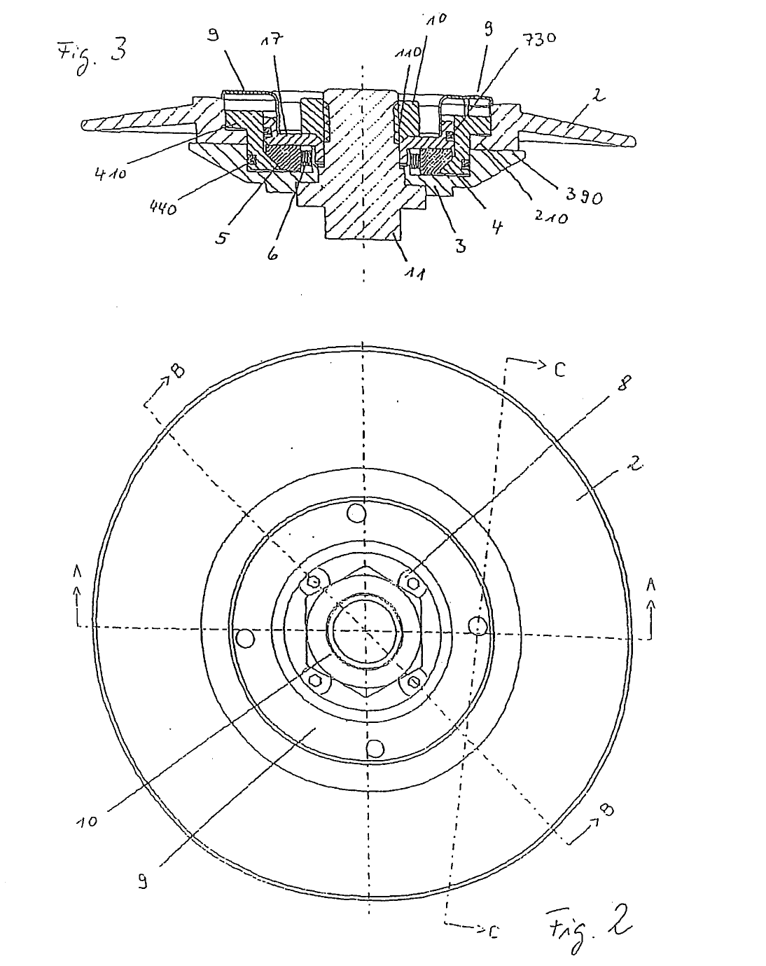

FIG. 2 shows a plan view of the fastening device of FIG. 1,

FIG. 3 shows a sectional view taken along line A-A of the fastening device shown in FIG. 2,

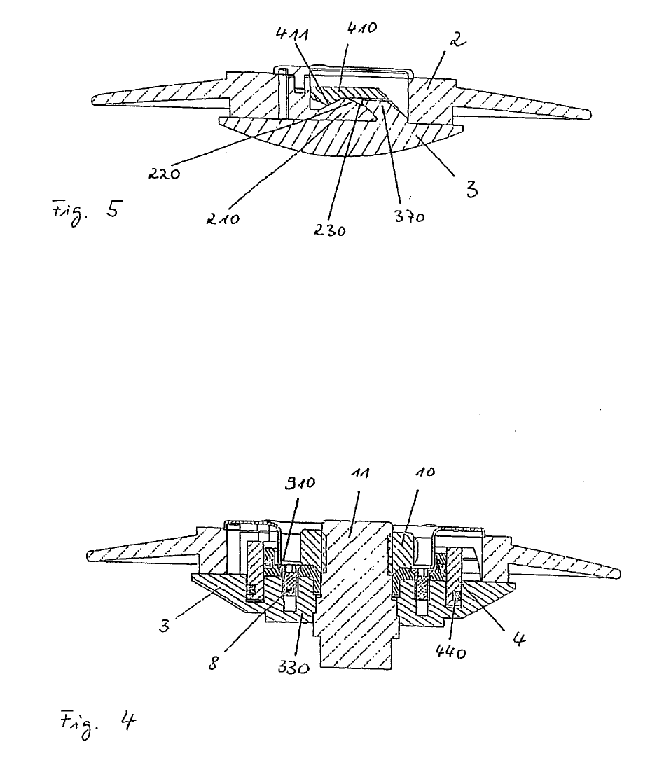

FIG. 4 shows a sectional view taken along line B-B of the fastening device shown in FIG. 2,

FIG. 5 shows a sectional view taken along line C-C of the fastening device shown in FIG. 2,

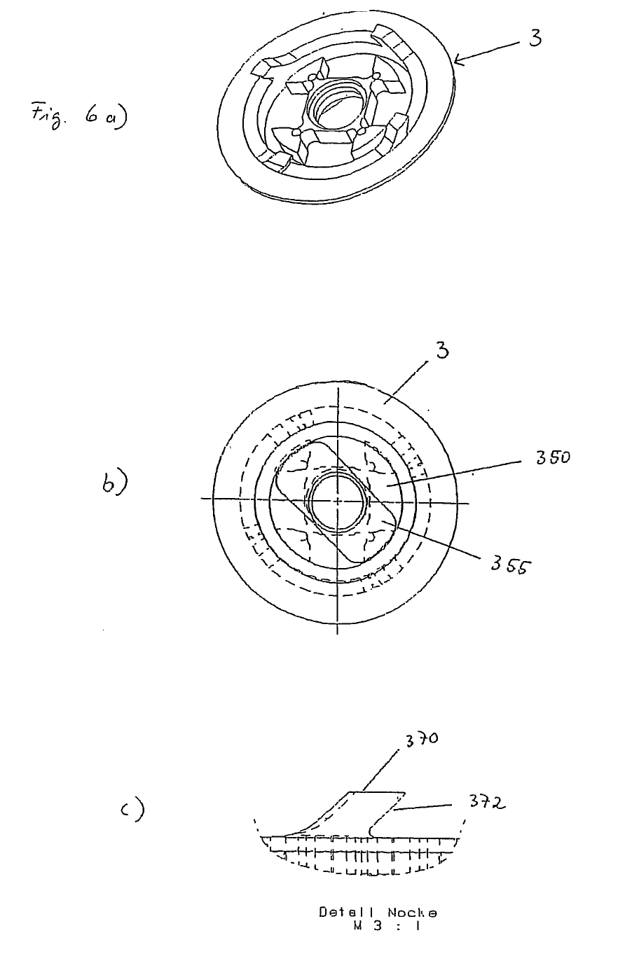

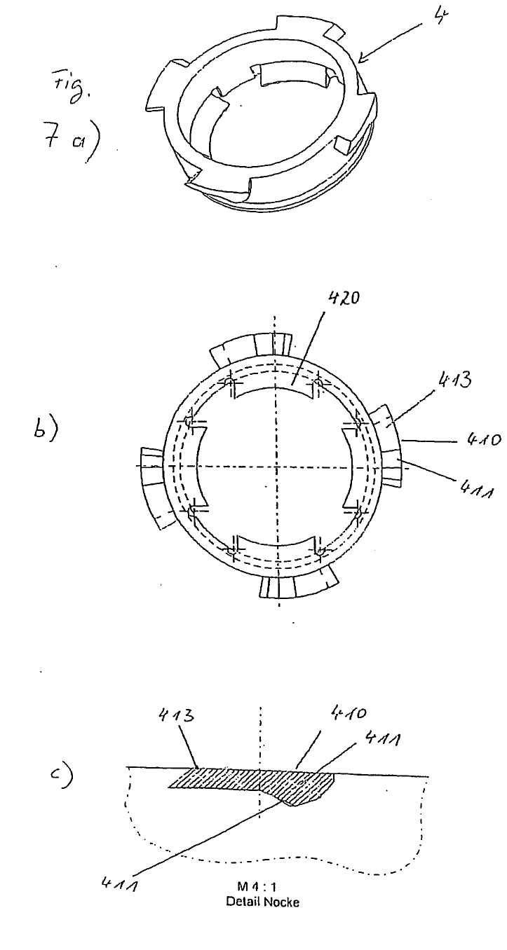

FIG. 6a shows a perspective view of a base element of the fastening device according to the invention,

FIG. 6b shows a view of the base element from below,

FIG. 6c shows the detail of an entrainment leg on the base element,

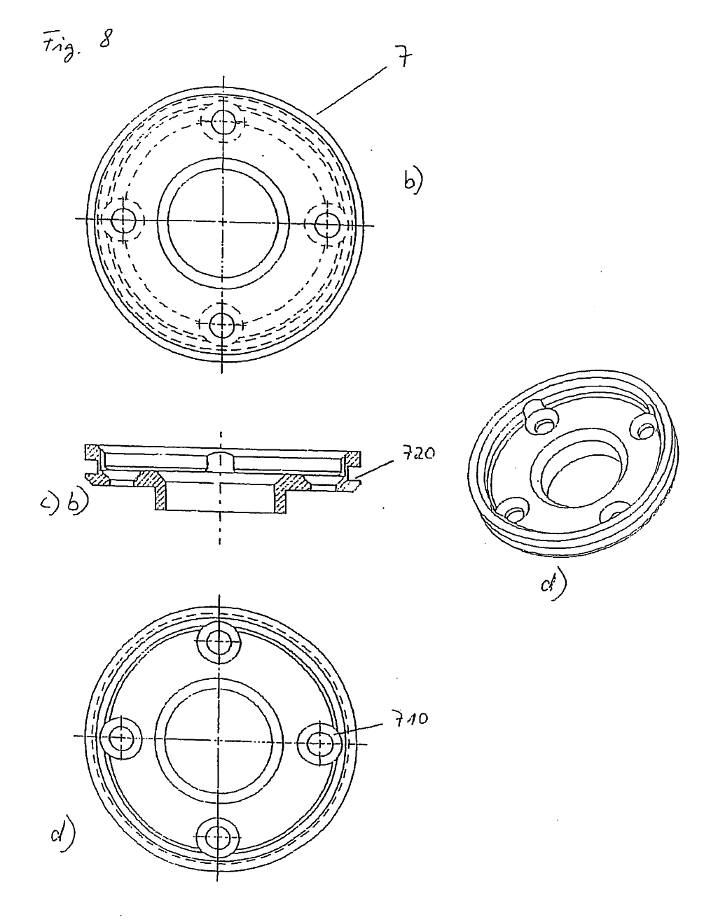

FIG. 7a shows an annular element of the fastening device according to the invention,

FIG. 7b shows a view of the annular element from below,

FIG. 7c shows a view on an enlarged scale illustrating the structure of a partially peripherally extending projection on the annular element,

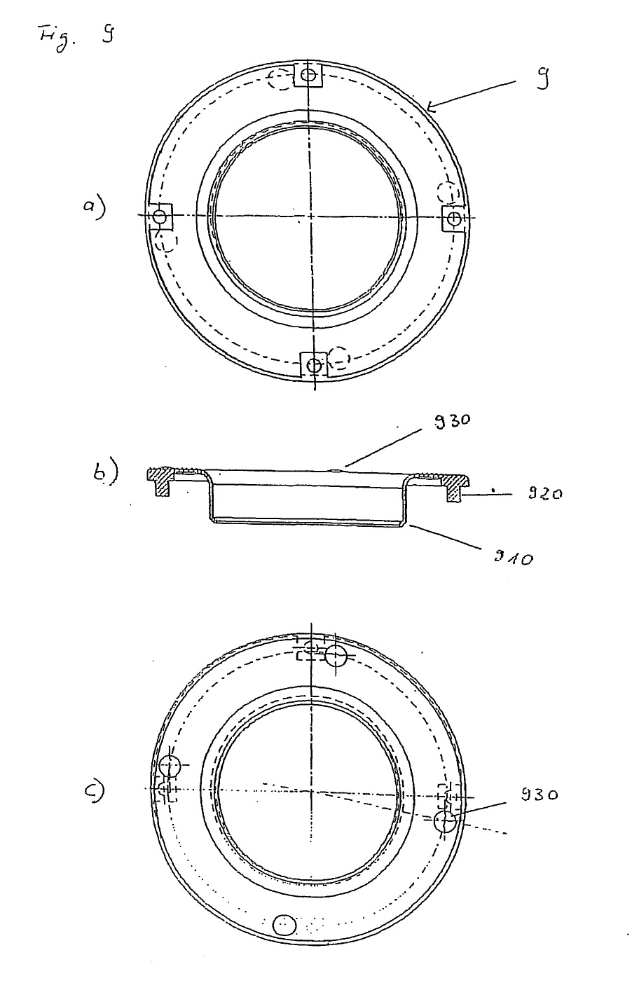

FIG. 8a shows a plan view of the cover of a fastening device according to the invention,

FIG. 8b shows a sectional view of the cover,

FIG. 8c shows a view of the cover from below,

FIG. 8d shows a perspective view of the cover,

FIG. 9a shows a plan view of a protective hood or cover which can be fitted from above onto a tool according to the invention,

FIG. 9b shows a sectional view of the protective cover,

FIG. 9c shows a view from below of the protective cover,

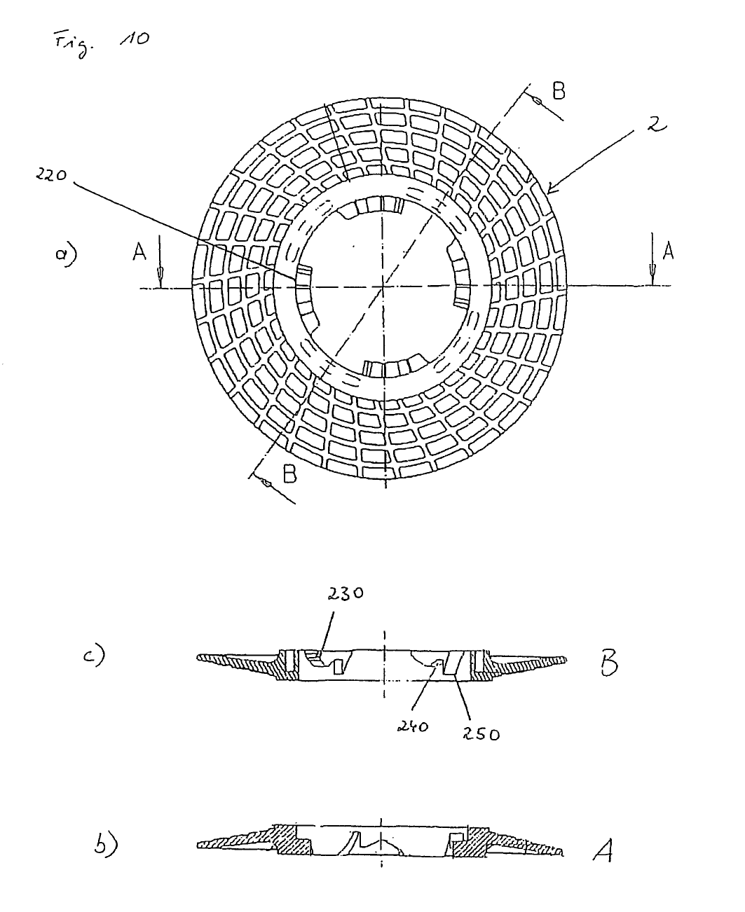

FIG. 10a shows a plan view of a carrier device of a tool in accordance with the invention,

FIG. 10b shows a sectional view taken along A-A of the carrier device,

FIG. 10c shows a sectional view taken along B-B of the carrier device,

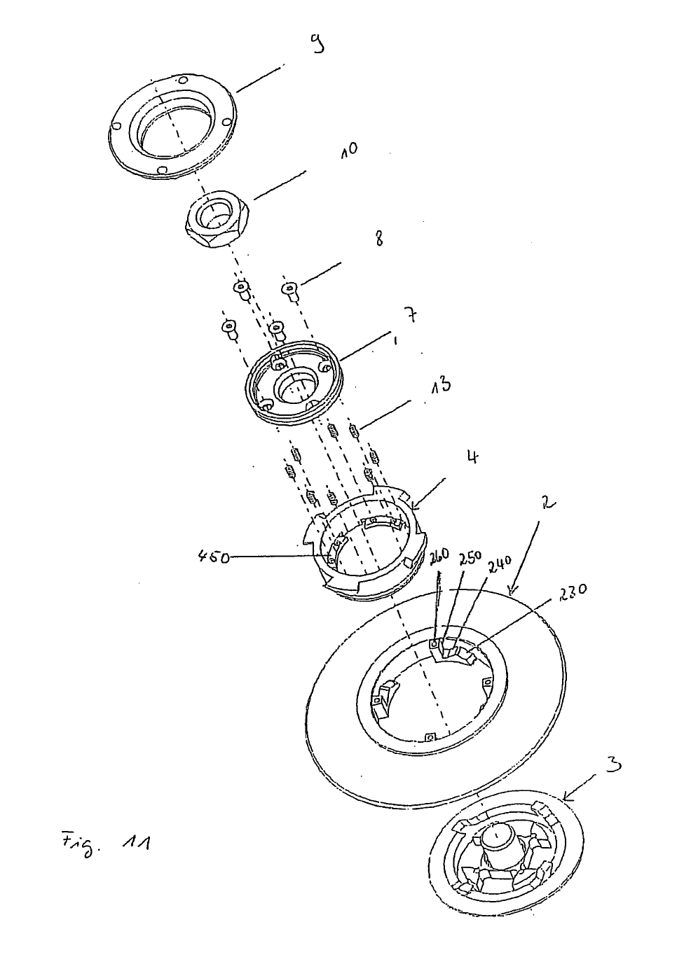

FIG. 11 shows an exploded view of a second embodiment of a fastening device according to the invention with associated tool,

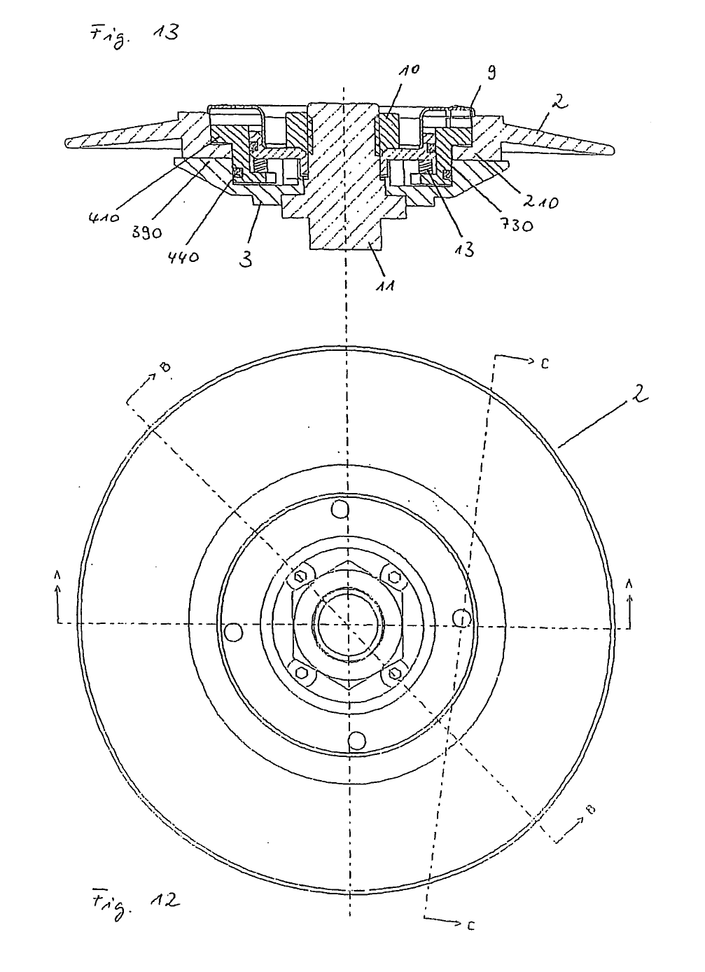

FIG. 12 shows a plan view of the fastening device illustrated in FIG. 11 in the assembled condition, and

FIG. 13 shows a sectional view taken along line A-A of the fastening device shown in FIG. 12.

FIG. 1 is an exploded view of a first embodiment of the fastening device according to the invention, which is shown together with the tool 2 to be clamped. The fastening device includes as essential component parts a base element 3, an annular element 4, four centrifugal force elements 5, by each of which two springs 6 are supported, and a cover 7 which can be screwed to the base element 3. For that purpose screws 8 extend through the cover into screwthreaded bores 310 on the base element.

It can be mounted by way of the nut 10 to the spindle of a machine tool (not shown). For that purpose the spindle of the machine tool extends through a central opening 320 to beyond the cover 7, in which case the latter has at its central opening a peripheral recess 710 into which the nut engages with a peripheral cone directed towards the machine tool for centring the entire arrangement on the machine tool.

The base element 3 has at peripheral spacings at an angle of 90° four cylindrical segment legs 330 which taper radially inwardly and blend into a bush portion 340 of the base element. The cylindrical segment legs 330 and the bush portion 340 extend to the bottom 350 of the base element 3. Four entrainment legs 370 extend on a flange 360 which is axially raised relative to the bottom, and are peripherally spaced at an angle of 90°. Depending on the respective embodiment involved the legs extend in the axial direction by some millimetres, in the present case by 5 millimetres. In the direction of rotation S the entrainment legs have a drive surface 372 which is arranged inclinedly with respect to the axis and by way of which the drive torque of the machine is transmitted to the tool 2. The drive surfaces are arranged radially for optimum transmission of the force, in other words they are disposed in parallel relationship with a radius of the device. Provided between the cylindrical segment legs 330 and the axial extent of the flange 360 downwardly towards the machine tool is a peripheral gap into which the annular element 4 can be inserted.

At the inner periphery, at its end directed towards the base element 3, the annular element has four cone segments 420, wherein provided between each two adjacent cone segments is a respective peripheral gap into which, upon being brought together with the base element 3, the cylindrical segment legs 330 of the latter engage so that the annular element is connected non-rotatably to the base element and accordingly is entrained thereby. The annular element has a degree of freedom, that is to say in the axial direction, in the base element. To seal off the base element relative to the axially movable annular element the latter has at the axial height of the cone segments a peripheral groove 430 into which a x-seal (not shown) is fitted. To provide for the axial displaceability of the annular element in the base element, the axial extent of the cylindrical segment legs 330 is greater than the axial extent of the cone segments 420 which are formed flush with the bottom of the cylindrical segment 4. The axial displaceability of the annular element which is necessary for setting the closure position as between the tool and the fastening device can be very small in the design configuration according to the invention and can be for example between two and four millimetres. Arranged at the outer periphery on the face of the annular element, which is in opposite relationship to the base element, there are four projections 410 which extend radially outwardly and which are structured towards the tool 2 in order to co-operate with the closure segments 210 of the tool 2 in a manner still to be described hereinafter to provide for an unsecured positively locking connection between the tool 2 and the fastening device 1.

As can be seen from FIG. 1, provided in relation to each cone segment 420 is a respective centrifugal force element 5 which bears thereagainst with a conical surface which is associated with the cone segment and which extends radially outwardly. The centrifugal force element bears with its lower boundary surface 530 against the bottom 350 of the base element and with its upper boundary surface 520 against the underside of the cover 7. That ensures that, irrespective of the position of the annular element 4, the centrifugal force elements 5 substantially cannot move axially but only radially. On the side surface 540 which is towards the axis and which is arranged in parallel relationship therewith the centrifugal force elements each have two blind holes into which is fitted a spring 6 which extends outwardly from the blind hole. The dimension of the spring is such that it is supported in any operative position by a flat side surface 380 of the bush portion of the base element 3. The described configuration provides that the centrifugal force elements 5 are coupled in respect of motion to the annular element 4 in any operative position, and the arrangement further provides a means for force deflection. As the centrifugal force elements bear under a spring force against the cone segments 420 of the annular member, an axially directed force therefore also acts in the rest position downwardly in a direction towards the base element. When the base element is not rotating the annular element 4 can be moved upwardly against the spring force of the springs 6 away from the support 390 on the base element, on which the tool 2 bears. When however the base element 3 is driven, then in addition to the spring forces, a centrifugal force acts on the centrifugal force elements 5, whereby the annular element and therewith also the projections provided thereon are pressed under a high force in a direction towards the support 390.

As the annular element 4 also moves with respect to the cover 7, the latter has a peripheral groove 720 in which a sealing ring (not shown in the Figure) is fitted.

FIG. 2 shows the fastening device of FIG. 1 in the assembled condition in a plan view thereof, in the situation where a tool 2 is clamped in the fastening device. A protective cover or hood 9 which has a horizontally extending flange and an axially extending peripheral surface is clipped onto the tool 2 in order to cover over the radial portion in the region of the projections 410 and the closure segments 210.

In another embodiment, the protective hood 9 shown in FIG. 2 can also be formed integrally on the tool or the carrier device of the tool 2.

FIG. 3 shows a view in section along line A-A of the fastening device illustrated in FIG. 1, with a tool clamped therein, the Figure showing a spindle 11 to which the fastening device is fastened by way of the nut 10. The tool 2 rests on the support 390 of the base portion, wherein, in the illustrated closure position, the axially inwardly facing closure segments 210 have radially outwardly facing projections 410 engaging thereover. As can also be seen from the drawings, the centrifugal force elements bear with their conical surfaces against the associated conical surfaces of the segments on the annular element, whereby the tool 2 is held down in the rest position by a spring force. The above-described protective hood 9 extends from an upper flange of the tool firstly horizontally inwardly and then extends axially downwardly with a sealing lip 910 which rests on the cover 7.

FIG. 4 shows a view in section taken along line B-B of the fastening device illustrated in FIG. 2, with the clamped tool 2. The Figure shows the screws 8 which are screwed into the screwthreaded bore 310 in the base portion 3 and by which the cover 7 is fastened to the base element. The Figure shows the sealing of the annular element 4 with the seal 440 in the region of the cylindrical segment legs 330.

FIG. 5 shows a section taken along line C-C in FIG. 2, that is to say in a radial region in which, when the tool is clamped in position, a positively locking connection is afforded between the outwardly facing projections 410 of the fastening device and the radially inwardly facing closure surface 220 of the tool 2, which is provided by the closure segment 210. In addition, in the specified positively locking condition, a respective entrainment leg 370 of the base element bears against a drive surface 230 of the closure segment for transmission of the drive torque to the tool. The projection 410 has a braking surface 411 which bears against a surface of a corresponding configuration on the tool and which carries braking forces which occur at the tool.

FIG. 6 shows the base element 3 as a perspective view (a) which has already been illustrated and as a view from below (b), wherein FIG. 6 shows a side view in detail of the structure of an entrainment leg 370. As shown in FIG. 6b), formed at the underside of the bottom 350 of the base element 3 is a central recess 355 in the form of a rectangle, into which an entrainment means of a corresponding configuration of the spindle of the machine tool engages, see for example FIG. 4. FIG. 6c) shows the configuration of an entrainment leg 370 with its associated drive surface 372 which bears in surface contact against the drive surface 230 of the tool. In the illustrated example the angle of the drive surfaces relative to the axis is 45°.

FIG. 7 shows the annular element 4 once again as a perspective view (a) and also as a view from the underside (b), wherein FIG. 7c) is a lateral view in section showing the structure of an outwardly radially extending projection as part of the tool-less closure arrangement. As can be seen the cone segments 420 extend to the end of the annular element 4. The configuration according to the invention at the underside, that is to say in the direction towards the tool, of the peripherally extending projections 410 can be seen from the views in FIGS. 7b) and c). On the side directed towards the tool the projections each have a respective cam 411 which for the clamping operation is designed to pass over a closure surface, of a corresponding configuration, of the tool. Starting from the cam, arranged in opposite relationship to the direction of rotation thereon is a horizontal leg 413 with which the projection is supported at an associated entrainment leg 370 when the tool is not in the clamped condition, see FIG. 5. The braking surface 411 shown in FIG. 7 for transmission of a braking moment from the tool to the annular element is in the present case at an angle of 30°.

FIGS. 8a) to d) show different perspectives of the cover 7 of the fastening device according to the invention. As can be seen from the view of the underside (FIG. 8c), the cover at its underside is of a substantially flat configuration so that the centrifugal force elements 5 bear thereagainst and as described are positively guided in the radial direction.

FIG. 9 shows various views of the protective hood 9. The protective hood 9 has at its underside peripherally equidistantly spaced, axially extending pegs 920 which can be fitted into suitably arranged holes 260 on the closure segments 210 of the tool, see FIG. 1. Advantageously the cover 9 can be made from a transparent plastic material which is elastic so that the sealing lip 910 can be formed integrally on the cover. In the FIG. 9 embodiment, the cover is made from a transparent material and also a convex raised portion 930 which performs the function of a lens is formed thereon in peripherally adjacent relationship with respective ones of the pegs. By virtue of their fastening to the closure segments of the tool those lenses are so arranged that they allow a view onto the contact of the respective projection 411 against the associated closure segment 210, thereby affording optical checking of the closure position as between the tool and the fastening device.

As described, the closure segments designed in accordance with the invention, with the closure surface which co-operates with the projection on the fastening device for affording a positively locking connection, can be provided directly on the tool body or also on a carrier device which carries the tool body.

FIG. 10 shows an example of such a carrier device which is similar to that shown in FIG. 1. In this respect, FIG. 10a) shows a plan view and FIGS. 10b) and c) respectively show views in section taken along lines A-A and B-B respectively. For axially guiding the cams 412 of the annular element, see FIG. 7, in the clamping operation and for providing a positively locking relationship between the projections of the fastening device and the closure surface, the tool 2 has a respective closure segment 210 which is provided with a structured closure surface 220 in a direction towards the projection 410 of the annular element. That closure surface 220 includes a first ramp 230 which at the same time is in the form of a drive surface for bearing against an entrainment leg 370 and accordingly is at an angle relative to the horizontal of 45° and is of an axially rising configuration. After reaching an axial maximum the surface falls away axially again in a second ramp 240. In the described embodiment that ramp is at an angle of 30° relative to the horizontal and serves as a contact for the braking surface 411 of the cam 412, see FIG. 5. The angle of the second ramp is kept less in comparison with the first ramp so that a worn tool can still be easily unclamped from the fastening device. It is to be borne in mind in that respect that a worn tool is generally of a smaller diameter so that, with the same application of force in comparison with the clamping operation, a smaller amount of torque can be developed by the user in the unclamping operation. That disadvantage is compensated by the lesser slope of the second ramp.

FIG. 11 shows an embodiment of the fastening device of the invention which manages without a centrifugal force device, that is to say the operating force for holding down the tool is produced solely by the inclined contact of the entrainment means 370 against the drive surface 230 of the closure segment 210 of the tool. A positively locking relationship in accordance with the understanding of the invention is implemented as in the first embodiment only in operation, that is to say upon rotation of the fastening device. It is only by virtue of the occurrence of an additional axial force, either caused by the entrainment legs or by the centrifugal force device and the entrainment legs, that the tool can be securely held on its support. A plurality of springs 13 are provided for holding the tool in the closure position in a rest condition of the fastening device, the springs 13 being supported against the cover 7 and pressing against horizontal segments 450 which extend radially inwardly at the interior of the annular element 4 and in the peripheral direction. As the further structure of the fastening device illustrated in FIG. 11 is substantially identical to that shown in FIG. 1, reference may be made to the first embodiment in regard to the further structure involved and the mode of operation concerned.

FIGS. 12 and 13 show a plan view and a sectional view respectively of the fastening device shown in FIG. 11, wherein, in regard to FIG. 13, attention is directed to the springs 13 which are clearly visible in the sectional view and which bear against the horizontal segments 450 and thus hold the annular element down, whereby the tool 2 is held on its support 390.

A tool designed in accordance with the invention can be brought into a closure position with the fastening device according to the invention by the tool with its closure segments being brought into the peripheral gaps between the projections of the fastening device, here the annular element, and being placed on the support 390. The tool and the fastening device are now moved relative to each other, for example the tool is moved in opposite relationship to the direction of rotation of the machine tool, while the fastening device is held fast. In that respect it is to be noted that, in the clamping operation, no direct axial force has to be applied by the user. With progressing rotary movement, the cam of the fastening device comes to bear against the first ramp on the tool, with the consequence, due to further rotary movement, that the cam of the projection is moved upwardly on the first ramp of the tool whereby the annular element is moved axially in the same manner. After the axially highest point of the closure surface of the tool is reached, the cam runs downwardly on the second ramp, by virtue of the axially operative spring force, whereby the cam comes to lie in a radially inwardly open pocket formed by the second ramp and the leg of the closure segment, see FIG. 5. That position of the cams relative to the closure segments in the closure position corresponds to a positively locking relationship which is secured as described by the occurrence of the axially directed operating forces.

### LIST OF REFERENCES

1 fastening device
2 tool, carrier device for tool body
3 base element
4 annular element
5 centrifugal force element
6 springs
7 cover
8 screws
9 protective hood
10 nut
11 spindle
12 carrier device
13 spring
210 closure segment
220 closure surface
230 drive surface, 1st ramp
240 braking surface, 2nd ramp
250 leg
260 receiving means
310 screwthreaded bore
320 opening
330 cylindrical segment leg
340 bush portion
350 bottom
355 recess
360 flange
370 entrainment leg
372 drive surface
380 flat side surface
390 support
410 projection
411 braking surface
412 cam
413 horizontal leg
420 cone segment
430 groove
440 seal
450 horizontal segment, flange segment
510 conical surface
520 upper boundary surface
530 lower boundary surface
540 side surface
710 recess
720 groove
730 seal
910 sealing lip
920 peg
930 raised portion
1110 annular cone on the nut

1. A fastening device for a machine tool for co-operation with a tool having a tool body in the form of a circular disc with a central opening, having a means for transmission of a drive torque to the tool and at least one projection of a closure means which can be actuated without a tool and with which the fastening device can be releasably connected to the tool, wherein in the closure position the at least one projection of the fastening device engages over an associated closure surface of the tool and the tool body is axially secured and held non-rotatably and the at least one projection and a support for the tool are arranged axially displaceably relative to each other, characterized in that the means for transmitting a drive torque has at least one entrainment member with a drive surface which extends inclinedly relative to the axis, the tool bearing against the drive surface.

2. A fastening device according to claim 1 characterized by a plurality of entrainment members which are rigidly connected to the support and which are arranged peripherally spaced from each other, wherein each entrainment member bears with its drive surface in positively locking relationship against an associated drive surface of the tool.

3. A fastening device for a machine tool for co-operation with a tool having a tool body in the form of a circular disc with a central opening, having a means for transmission of a drive torque to the tool and at least one projection of a closure means which can be actuated without a tool and with which the fastening device can be releasably connected to the tool, wherein in the closure position the at least one projection of the fastening device engages over an associated closure surface of the tool and the tool body is axially secured and held non-rotatably and the at least one projection and a support for the tool are arranged axially displaceably relative to each other, wherein the axial displacement path can be blocked by a centrifugal force device, characterised in that the centrifugal force device has at least one centrifugal force element which is urged radially outwardly by a force means, and a means which converts the force on the at least one centrifugal force element for producing an axially directed force for clamping the tool in the fastening device, wherein the at least one centrifugal force element assumes a substantially identical radial position both in a rest operative position and also upon the engagement of a centrifugal force.

4. A fastening device according to claim 3 characterised in that the at least one centrifugal force element has a radially outward wedge or conical surface which extends in particular at an angle of 45° relative to the axis and which in rest operative position is moved by the force means into a condition of bearing against an associated wedge or conical surface of an axially movable wedge or cone segment which is operatively connected to the at least one projection of the fastening device.

5. A fastening device according to claim 4 characterised in that the centrifugal force element is immobile in the axial direction and the associated wedge or cone segment is positively guided immovably in a direction perpendicular to the axis.

6. A fastening device according to claim 1 characterised by a base element which includes the support for the tool and an annular element which can be axially introduced into the base portion and which is axially displaceable relative thereto and at the outer periphery of which are arranged a plurality of peripherally spaced, radially outwardly facing projections.

7. A fastening device according to claim 3 characterised in that provided at the inner periphery of the annular element are a plurality of radially inwardly extending, peripherally spaced wedge or cone segments each having a respective radially inwardly directed contact surface.

8. A fastening device according to claim 1 characterised in that provided at the inner periphery of the annular element are a plurality of radially inwardly extending, peripherally spaced flange segments and at which axially operative force means are supported for clamping the tool between the support and the at least one projection in the fastening device.

9. A fastening device according to claim 6, characterised in that provided on the annular element by two peripherally spaced wedge, cone or flange segments between them is a peripheral gap which positively lockingly engages a leg which is rigidly connected to the base element and which is peripherally extensive and which extends in the axial direction, to provide a non-rotatable mounting of the annular element in relation to the base element and displaceability of the annular element in the axial direction.

10. A fastening device according to claim 6 characterised in that the annular element has at the outer periphery a peripheral groove for receiving a means for sealing in relation to the base element.

11. A fastening device according to claim 6 characterised in that the annular element is supported against the entrainment means of the base element.

12. A fastening device according to claim 7 characterised in that the base element can be rigidly connected to the machine tool.

13. A fastening device according to claim 1 characterised in that a radially outwardly facing projection of the fastening device has a cam which extends towards the machine tool, with contact surfaces which are front and rear surfaces in the direction of rotation S.

14. A fastening device according to claim 13 characterised in that a horizontally and peripherally extending leg extends from the cam to an associated entrainment member on which the projection rests when the tool is not in a clamped condition.

15. A tool comprising a tool body which is in the form of a circuit disc and which has a central opening for fastening to a machine tool, with at least one closure surface of a closure means which can be actuated without a tool, with which the tool can be releasably connected to a fastening device, wherein in the closure position at least one projection on the fastening device engages over the at least one closure surface of the tool and the tool body is axially secured and held non-rotatably, characterised in that the at least one closure surface is provided by a peripherally extending segment which also has a means for axially guiding a cam of the at least one projection of the fastening device during the clamping operation.

16. A tool according to claim 15 characterised in that the means for axially guiding the cam of the fastening device during the clamping operation has, in the direction of rotation, a first ramp which is disposed inclinedly relative to the axis and behind the first ramp a second ramp which is disposed inclinedly with respect to the axis.

17. A tool according to claim 15 characterised in that the first ramp is additionally in the form of drive surface against which after the clamping operation an associated entrainment member of the fastening device bears with its drive surface for transmission of the drive torque.

18. A tool according to claim 16 characterised in that the first ramp is at an angle of 25 to 45 degrees in a plane in perpendicular relationship to the axis.

19. A tool according to claim 18 characterised in that the first ramp is at an angle of 30 degrees in a plane in perpendicular relationship to the axis and the second ramp is at an angle ≦30 degrees in a plane perpendicular to the axis.

20. A tool according to claim 15 characterised in that at the end thereof in opposite relationship to the direction of rotation the segment has a leg extending axially to the end remote from the machine tool.

21. A tool according to claim 15 characterised in that segments providing closure surfaces are formed on a carrier device which is provided in an opening in the tool body and is fixed thereto.

22. A method of tool-free clamping of a tool on a fastening device for a machine tool, wherein the tool and the fastening device are axially aligned in an open position of the closure means and brought together, and a closure position is produced by rotary movement, in which position at least one, in particular radially outwardly facing projection of the fastening device engages over an in particular radially inwardly facing closure surface of the tool so that the tool body is held axially secured and a positively locking connection is made between the fastening device and the tool, characterised in that upon rotation of the tool relative to the fastening device a reversal of movement is effected for changing the axial spacing of the at least one projection of the fastening device relative to a support of the tool, the relative axial displacement being produced by means of a pure rotary movement by means of force deflection.

23. A method according to claim 22 characterised in that in the rotary movement to produce a closure position a cam is automatically guided by way of a cam control between the tool and the fastening device by way of a surface with at least two ramps, wherein the at least one projection of the fastening device is raised axially with respect to the support against a mechanical force means and is lowered again.

24. A method according to claim 23 characterised in that the cam is continuously guided by way of the surface acting as a control means by the relative rotary movement between the tool and the fastening device throughout the entire clamping operation.

25. A method according to claim 23 characterised in that in the rotary movement a cam on the fastening device is guided over a control surface on the tool.

26. A method according to claim 23 characterised in that in the rotary movement a cam on the tool is guided over a control surface on the fastening device.

27. A method according to claim 23, characterised in that with the lowering movement a positively locking engagement is achieved between the fastening device and the tool.

28. A method according to claim 23 characterised in that upon unclamping of the tool from the fastening device a relative rotary movement of the tool with respect to the fastening device is produced manually, that rotary movement being in opposite relationship to that involved in the clamping operation, whereby the tool and the fastening device are brought out of engagement by release of the positively locking engagement by way of the force deflection effect by means of guidance of the cam over the control surface.

29. A method according to claim 22 characterised in that during operation a force is produced which acts in the axial direction and which presses the tool against its support in the fastening device.
